(19) United States
(12) Patent Application Publication
(10) Pub. No.: US 2026/0091695 A1
(43) Pub. Date: Apr. 2, 2026

(54) Protection Against Physical Damage to Electric Vehicle Charging Cables

(71) Applicant: ChargePoint, Inc., Campbell, CA (US)

(72) Inventors: Dennis Michael Heleine, Morgan Hill, CA (US); Hossein Kazemi, San Francisco, CA (US); Aaron Dayton Little, Campbell, CA (US); William Rich, Emerald Hills, CA (US); Richard Craig Wilmer, Saratoga, CA (US)

(21) Appl. No.: 19/041,761

(22) Filed: Jan. 30, 2025

Related U.S. Application Data
(60) Provisional application No. 63/700,090, filed on Sep. 27, 2024.
(60) Provisional application No. 63/728,105, filed on Dec. 4, 2024.

(51) Int. Cl. B60L 53/18; B60L 53/302; H01B 7/18; H01B 7/29

(52) U.S. Cl. CPC B60L 53/18; B60L 53/302; H01B 7/1815; H01B 7/292

(57) ABSTRACT

An electric vehicle (EV) charging cable for charging electric vehicles is described. The EV charging cable includes power conductors, a ground conductor, and a signal conductor. The EV charging cable further includes hard metal cordages within the EV charging cable and cut resistant plastic cordages that are positioned about the hard metal cordages respectively. The EV charging cable further includes a cable jacket that surrounds the interior components of the cable.

### CROSS-REFERENCE TO RELATED APPLICATIONS

This application claims the benefit of U.S. Provisional Application No. 63/728,105,filed Dec. 4, 2024, and U.S. Provisional Application No. 63/700,090, filed Sep. 27, 2024, which are hereby incorporated by reference.

### FIELD

Embodiments of the invention relate to the field of electric vehicle (EV) charging systems; and more specifically to the protection against physical damage to EV charging cables.

### BACKGROUND

In recent years, the adoption of electric vehicles has significantly increased, necessitating the widespread availability of reliable and secure charging infrastructure. Charging cables, which connect EVs to charging stations, are critical components in this infrastructure. However, these cables are susceptible to vandalism, theft, and accidental damage, particularly in public and unattended charging locations. Such damage can lead to costly repairs, potential hazards, and disruption of service for EV users.

### SUMMARY

In some aspects, the techniques described herein relate to an electric vehicle (EV) charging cable for charging electric vehicles. The EV charging cable includes power conductors, a ground conductor, and a signal conductor. The EV charging cable further includes hard metal cordages within the EV charging cable and cut resistant plastic cordages that are positioned about the hard metal cordages respectively. The EV charging cable further includes a cable jacket that surrounds the interior components of the cable. The cut resistant plastic cordages may be made from a Kevlar material or a High Molecular Weight Polyethylene (HMWPE) material. At least two cut resistant plastic cordages may be positioned on opposing ends of each of the hard metal cordages. The hard metal cordages may be made from a material that has a hardness level above a low-carbon steel, such as stainless steel. The diameter of each of the hard metal cordages may be between 1 mm and 5 mm. The hard metal cordages may be positioned approximately symmetrically within the EV charging cable. The number of hard metal cordages may be greater than five. The EV charging cable may further include one or more cooling channels for liquid cooling or air cooling. The EV charging cable may further include non-protective filler elements.

### BRIEF DESCRIPTION OF THE DRAWINGS

The invention may best be understood by referring to the following description and accompanying drawings that are used to illustrate embodiments of the invention. In the drawings:

FIG. 1 illustrates a cross-section view of an EV cable that includes cable protection according to an embodiment.

FIG. 2 illustrates a cross-section view of an EV cable that includes cable protection according to an embodiment.

FIG. 3 illustrates a cross-section view of an EV cable that includes cable protection according to an embodiment.

FIG. 4 illustrates a cross-section view of an EV cable that includes cable protection according to an embodiment.

FIG. 5 illustrates a cross-section view of an EV cable that includes cable protection according to an embodiment.

FIG. 6 illustrates a cross-section view of an EV cable that includes cable protection according to an embodiment.

FIG. 7 illustrates a cross-section view of an EV cable that includes cable protection according to an embodiment.

FIG. 8 illustrates a cross-section view of an EV cable that includes cable protection according to an embodiment.

FIG. 9 illustrates a cross-section view of an EV cable that includes cable protection according to an embodiment.

FIG. 10 illustrates a cross-section view of an EV cable that includes cable protection according to an embodiment.

FIG. 11 illustrates a cross-section view of an EV cable that includes cable protection according to an embodiment.

FIG. 12 illustrates a cross-section view of an EV cable that includes cable protection according to an embodiment.

FIG. 13 illustrates a cross-section view of an EV cable that includes cable protection according to an embodiment.

FIG. 14 illustrates a cross-section view of an EV cable that includes cable protection according to an embodiment.

FIG. 15 illustrates a cross-section view of an EV cable that includes cable protection according to an embodiment.

FIG. 16 illustrates a cross-section view of an EV cable that includes cable protection according to an embodiment.

FIG. 17 illustrates a cross-section view of cable protection for an EV cable according to an embodiment.

FIG. 18 shows the protective wrap of FIG. 17 built using an offset design to spiral wrap an EV charging cable according to an embodiment.

FIG. 19 shows an exemplary embodiment of an electric vehicle supply equipment (EVSE) according to an embodiment.

### DESCRIPTION OF EMBODIMENTS

Protecting an EV cable from physical damage is described. In one embodiment, protection is integrated in the EV charging cable. In another embodiment, a sleeve or wrap is applied to an EV charging cable to provide protection. In either embodiment, the durability and security of EV charging cables is enhanced.

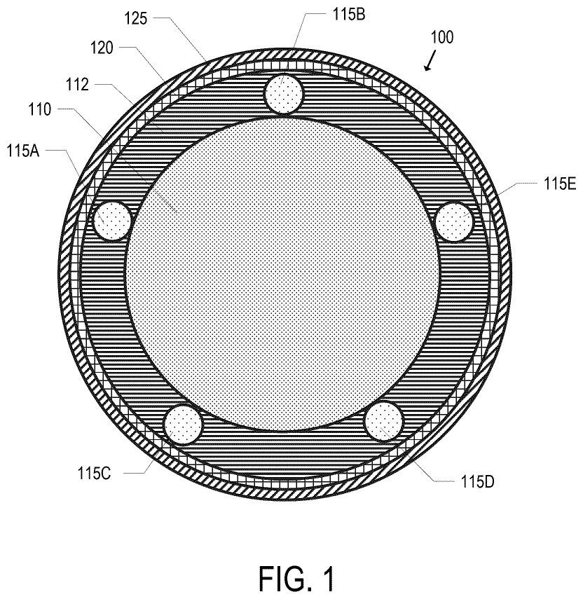

FIG. 1 illustrates a cross-section view of an EV cable that includes cable protection according to an embodiment. In the embodiment shown in FIG. 1, the protective elements of the EV charging cable 100 are integrated into the construction of the charging cable 100.

The core 110 is the inner layer of the charging cable 100 and includes the power conductors (e.g., wires that carry the electrical current), communication wire(s) (e.g., for communication between the EV and the charging station), ground wire(s), and may include other components (e.g., insulation). If the charging cable 100 is a liquid cooled cable, the core 110 may also include one or more cooling channels or tubes for carrying a coolant. If the charging cable 100 is an air-cooled cable, the core 110 may also include one or more cooling channels or tubes for carrying air. The core 110 may not be covered by a cable jacket.

A foam filler layer 112 surrounds the core 110. Hard metal cordages 115A-115E are placed throughout the foam filler layer 112. A hard metal cordage is a metal material that provides strength and resilience to most cutting tools. The hardness of the hard metal cordage will dull or damage typical cutting blades. The hardness of the hard metal cordage provides a high level of resistance to power tools requiring more time to cut through. However, the hardness of the hard metal cordage is weak to high levered force hardened tool steel typical of tools with a small cutting surface like a bolt cutter. A common cutting tool has cutting edges that are between 600-750 HV (Vickers Hardness). In an embodiment, a steel that has a hardness level above a low-carbon steel may be used as the hard metal cordage (e.g., a medium-carbon steel that ranges between 150-550 HV, a high-carbon steel that ranges between 200-850 HV, tool steel (e.g., High-Speed Steel (HSS)) that ranges between 700-850 HV, stainless steel that ranges between 200-600 (e.g., stainless steel type 316 is between 300-400 HV), chromoly steel that ranges between 300-700, and maraging steel that ranges between 500-700). The material is twisted, braided, or otherwise formed in a rope, cable, or metal band (e.g., steel rope, steel cable, steel band).

The hard metal cordages 115A-115E may be between 1 mm and 5 mm in diameter. The positioning of the hard metal cordages within the cable helps to protect the cable. In an embodiment, the hard metal cordages are arranged approximately symmetrically (e.g., as shown in the figure). This symmetrical arrangement offers more protection compared to other spacing configurations, such as bunching, which can make cutting the cordages easier. Although there are five hard metal cordages illustrated in FIG. 1, the number is exemplary. In other embodiments there may be more or fewer hard metal cordages.

A woven braid 120 surrounds the foam filler layer 112. The woven braid 120 may be a high molecular weight polyethylene (HMWPE) braid. The woven braid 120 may be a finger trap style where the inner diameter shrinks when the braid is pulled lengthwise. The woven braid 120 provides 360 degree coverage and adds length to the strands in the conductor (the pull instead of cutting). This tends to trap between the two shearing surface of the blades of the cutting device. The foam filler layer 112 may be a closed cell foam that provides “movable areas” in the cable which helps to foul the cutting device as the steel ropes move through the cutting process. The hard metal cordages 115A-115E and the woven braid 120 work together to defeat and foul the blades of the cutting device.

A cable jacket 125 surrounds the woven braid 120. The cable jacket 125 protects the internal components from environmental factors and mechanical stresses. The cable jacket 125 can be made from UL62 EV or EVE materials.

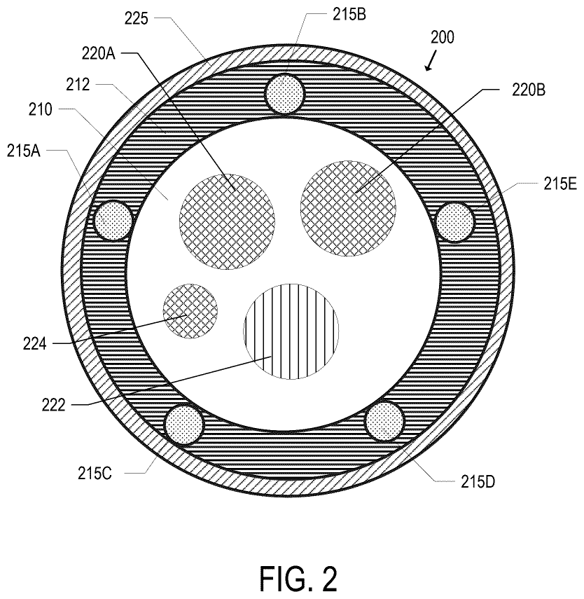

FIG. 2 illustrates a cross-section view of an EV cable that includes cable protection according to an embodiment. In the embodiment shown in FIG. 2, the protective elements of the EV charging cable 200 are integrated into the construction of the charging cable 200.

The core 210 is the inner layer of the charging cable 200 and includes the power conductors 220A and 220B, the ground conductor 222, and the signal conductor 224. The power conductors 220A and 220B are used to carry the rated current and may include multiple pairs of wires. Although there are two power conductors shown in FIG. 2, there may be more power conductors (e.g., four power conductors) depending on the cable variant (e.g., more power conductors may be used to reduce individual wire size and reduce overall cable diameter as smaller conductors pack better than larger conductors). The ground conductor 222 is used as a ground and sized to meet regulatory safety requirements. The signal conductor 224 is used to carry data signals and may include multiple wires, which can be bunched together or distributed throughout the charging cable 200. The core 210 may not be covered by a cable jacket.

A cut resistant plastic filler layer 212 surrounds the core 210. Such a cut resistant plastic filler is a material that is resistant to cutting blades and can be made from material such as Kevlar or High Molecular Weight Polyethylene (HMWPE). The cut resistant plastic filler acts as a fouling mechanism. Reciprocating blades will pull the strands into the cutting area resulting and bunching and slowing of the tool. Its resilience to cutting allows it to slip between cutting blades of shear style cutters. Even a smooth sharp blade requires a sawing motion to get through the cut resistant plastic filler. However, the weakness of the cut resistant plastic filler is heat typical to grinding wheel style cutters.

Hard metal cordages 215A-215E are placed throughout the cut resistant plastic filler layer 212. A hard metal cordage is a metal material that provides strength and resilience to most cutting tools. The hardness of the hard metal cordage will dull or damage typical cutting blades. The hardness of the hard metal cordage provides a high level of resistance to power tools requiring more time to cut through. However, the hardness of the hard metal cordage is weak to high levered force hardened tool steel typical of tools with a small cutting surface like a bolt cutter. A common cutting tool has cutting edges that are between 600-750 HV (Vickers Hardness). In an embodiment, a steel that has a hardness level above a low-carbon steel may be used as the hard metal cordage (e.g., a medium-carbon steel that ranges between 150-550 HV, a high-carbon steel that ranges between 200-850 HV, tool steel (e.g., High-Speed Steel (HSS)) that ranges between 700-850 HV, stainless steel that ranges between 200-600 (e.g., stainless steel type 316 is between 300-400 HV), chromoly steel that ranges between 300-700, and maraging steel that ranges between 500-700). The material is twisted, braided, or otherwise formed in a rope, cable, or metal band (e.g., steel rope, steel cable, steel band).

The hard metal cordages 215A-215E may be between 1 mm and 5 mm in diameter. The positioning of the hard metal cordages within the cable helps to protect the cable. In an embodiment, the hard metal cordages are arranged approximately symmetrically (e.g., as shown in the figure). This symmetrical arrangement offers more protection compared to other spacing configurations, such as bunching, which can make cutting the cordages easier. Although there are five hard metal cordages illustrated in FIG. 1, the number is exemplary. In other embodiments there may be more or fewer hard metal cordages.

The use of the cut resistant plastic filler layer and the hard metal cordage together provides for a wide range of coverage and overlap of protection resulting in a high rate of tool fouling or damage.

The core 210 may also include non-protective filler such as thermoplastic fillers (e.g., polyethylene). The non-protective filler elements help keep the cable uniform by preventing gaps between the conductors and other elements.

A cable jacket 225 surrounds the cut resistant plastic filler layer 212. The cable jacket 225 protects the internal components from environmental factors and mechanical stresses. The cable jacket 225 can be made from UL62 EV or EVE materials.

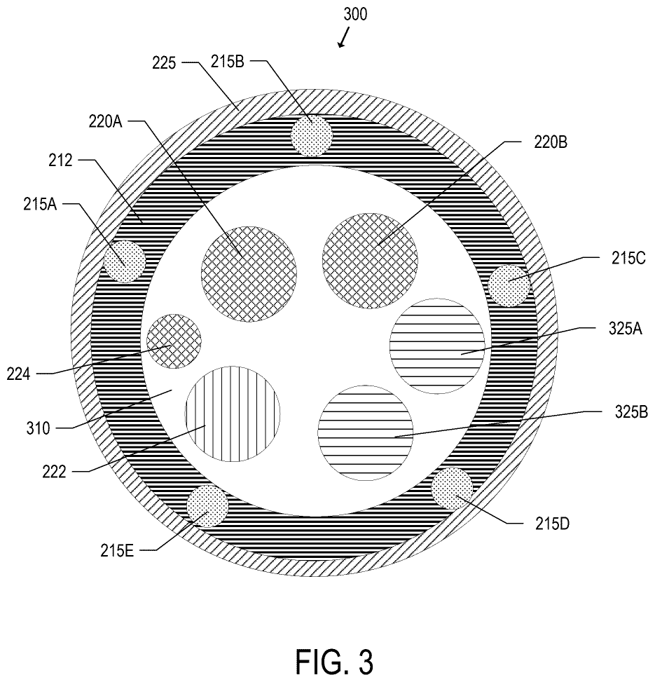

FIG. 3 illustrates a cross-section view of an EV cable that includes cable protection according to an embodiment. In the embodiment shown in FIG. 3, the protective elements of the EV charging cable 300 are integrated into the construction of the charging cable 300. The charging cable 300 is like the charging cable 200 but also includes cooling channels 325A and 325B for carrying a liquid coolant or tubes for carrying air. Thus, the core 310 includes the power conductors 220A and 220B, the ground conductor 222, the signal conductor 224, and the cooling channels 325A and 325B. The power conductors 220A and 220B are used to carry the rated current and may include multiple pairs of wires. Although there are two power conductors shown in FIG. 3, there may be more power conductors (e.g., four power conductors) depending on the cable variant (e.g., more power conductors may be used to reduce individual wire size and reduce overall cable diameter as smaller conductors pack better than larger conductors). The ground conductor 222 is used as a ground and sized to meet regulatory safety requirements. The signal conductor 224 is used to carry data signals and may include multiple wires, which can be bunched together or distributed throughout the charging cable 200. The number of cooling channels is exemplary. In other embodiments, there may be one, or more than two, cooling channels.

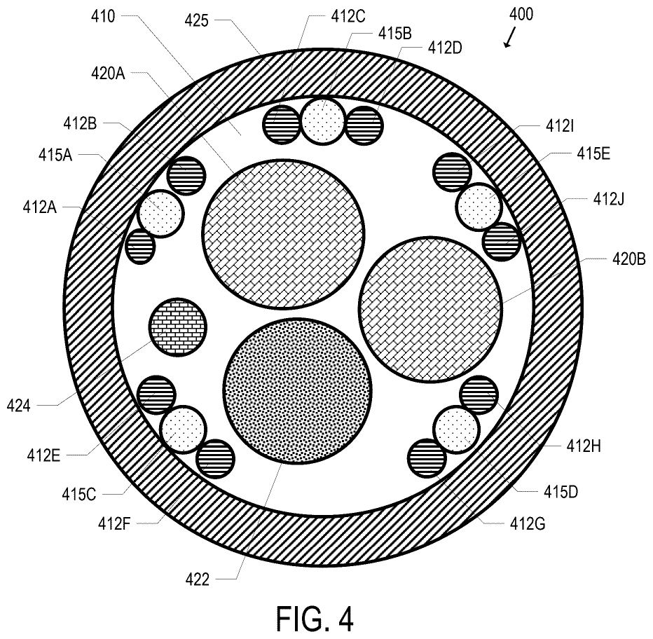

FIG. 4 illustrates a cross-section view of an EV cable that includes cable protection according to an embodiment. In the embodiment shown in FIG. 4, the protective elements of the EV charging cable 400 are integrated into the construction of the charging cable 400. Unlike the embodiments shown in FIGS. 1-3 , the protective elements of the charging cable are within the core of the charging cable 400. Conventional cables include non-protective filler in the core of the charging cable 400. In the embodiment shown in FIG. 4, at least some of the non-protective filler is replaced with the protective elements (e.g., hard metal cordages, cut resistant plastic filler).

The embodiments shown in FIGS. 1-3 will typically increase the size of a charging cable to incorporate cable protection. In contrast, the embodiments shown in FIGS. 4-16 do not materially enlarge the cable size to incorporate cable protection. The embodiments shown in FIGS. 1-3 may provide more protection compared to the embodiments shown in FIG. 4 16 because the inner conductors are better protected in the event of a theft event. However, the embodiments shown in FIGS. 4-16 have a lower outer diameter (OD) which increases usability and backwards compatibility. For instance, a cable according to the embodiments of FIGS. 1-3 may require a change in design of the electric vehicle supply equipment (EVSE) or require an adapter or modification; whereas a cable according to the embodiments of FIG. 4 16 can be used without requiring a change in the design of the EVSE or an adapter or modification. Further, a cable according to the embodiments of FIGS. 4-16 will typically be lighter and more flexible compared to the cable of the embodiments shown in FIGS. 1-3 .

The core 410 is the inner layer of the charging cable 400 and includes conductors (the power conductors 420A and 420B, the ground conductor 422, and the signal conductor 424) and the protective elements. The power conductors 420A and 420B are used to carry the rated current and may include multiple pairs of wires. The signal conductor 424 is used to carry data signals and may include multiple wires, which can be bunched together or distributed throughout the charging cable 400. The ground conductor 422 is used as a ground and sized to meet regulatory safety requirements.

The core 410 also includes the protective elements including the hard metal cordages 415A-415E and the cut resistant plastic cordage 412A-412J. The hard metal cordages 415A-415E are like the hard metal cordages 115A-115E. Although there are five hard metal cordages illustrated in FIG. 4, the number is exemplary. In other embodiments there may be more or fewer hard metal cordages. The number of hard metal cordages is a balance between protection and usability of the cable. Each hard metal cordage that is added, while increasing protection, increases the weight of the charging cable and reduces its flexibility, thereby reducing its usability. For instance, one hard metal cordage provides a minimum level of protection but maximum usability; while having a number of hard metal cordages that provides a full circumference coverage provides a maximum level of protection but minimum usability. The number of hard metal cordages is also dependent on the space available within the cable. For example, a cable that has more non-protective filler may allow for more hard metal cordages compared to a cable that has relatively less non-protective filler.

The positioning of the hard metal cordages within the cable 400 helps to protect the cable. In an embodiment, the hard metal cordages are arranged approximately symmetrically (e.g., as shown in the figure). This symmetrical arrangement offers more protection compared to other spacing configurations, such as bunching, which can make cutting the cordages easier.

The core 410 also includes the cut resistant plastic cordages 412A-412J. The cut resistant plastic cordages are resistant to cutting blades and can be made from material such as Kevlar or High Molecular Weight Polyethylene (HMWPE). The cut resistant plastic cordage acts as a fouling mechanism. Reciprocating blades will pull the strands into the cutting area resulting and bunching and slowing of the tool. Its resilience to cutting allows it to slip between cutting blades of shear style cutters. Even a smooth sharp blade requires a sawing motion to get through the cut resistant plastic cordage. However, the weakness of the cut resistant plastic cordage is heat typical to grinding wheel style cutters.

As shown in FIG. 4, there are two bundles of cut resistant plastic cordage on opposing sides of each hard metal cordage. That is, the cut resistant plastic cordages 412A and 412B are placed on opposing sides of the hard metal cordage 415A, the cut resistant plastic cordages 412C and 412D are placed on opposing sides of the hard metal cordage 415B, the cut resistant plastic cordages 412E and 412F are placed on opposing sides of the hard metal cordage 415C, the cut resistant plastic cordages 412G and 412H are placed on opposing sides of the hard metal cordage 415D, and the cut resistant plastic cordages 412I and 412J are placed on opposing sides of the hard metal cordage 415E.

Although FIG. 4 shows two bundles of cut resistant plastic cordage on opposing sides of each hard metal cordage, in other embodiments there may be one bundle of cut resistant plastic cordage for each hard metal cordage, in other embodiments there may be more than two bundles of cut resistant plastic cordage for each hard metal cordage, and in other embodiments there may be any combination of the number of cut resistant plastic cordages for each hard metal cordage.

Although not directly shown in FIG. 4, the core 410 may also include non-protective filler such as thermoplastic fillers (e.g., polyethylene). The non-protective filler elements help keep the cable uniform by preventing gaps between the conductors and other elements. Further, the internal elements of the core 410 can be wrapped in a fabric (e.g., a tape) to bundle the elements together into a tight bundle for extrusion.

The internal elements of the core 410 can be twisted throughout the length of the cable 400 or can be arranged in a straight line.

The use of the cut resistant plastic cordage and the hard metal cordage together provides for a wide range of coverage and overlap of protection resulting in a high rate of tool fouling or damage.

A cable jacket 425 surrounds the core 410. The cable jacket 425 protects the internal components from environmental factors and mechanical stresses. The cable jacket 425 can be made from UL62 EV or EVE materials.

FIG. 4 is not to scale. The sizes of the conductors (e.g., the power conductors 420A and 420B, the ground conductor 422, and the signal conductor 424) can vary, which can impact the diameter of the charging cable 400. For example, larger conductors typically lead to a larger cable diameter compared with relatively smaller conductors.

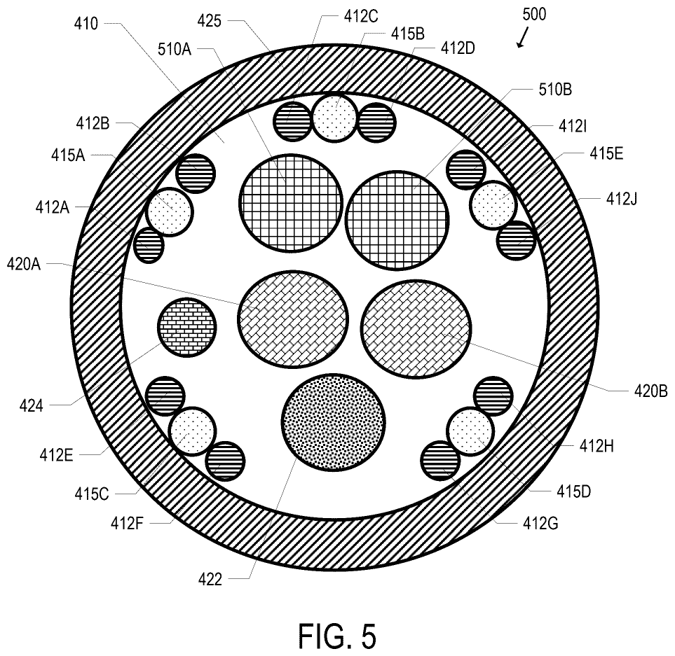

FIG. 5 illustrates a cross-section view of an EV cable that includes cable protection according to an embodiment. In the embodiment shown in FIG. 5, the protective elements of the EV charging cable 500 are integrated into the construction of the charging cable 500. The charging cable 500 is like the charging cable 400 but also includes cooling channels 510A and 510B for carrying a liquid coolant or tubes for carrying air. Thus, the core 410 includes the power conductors 420A and 420B, the ground conductor 422, the signal conductor 424, and the cooling channels 510A and 510B. The power conductors 420A and 420B are used to carry the rated current and may include multiple pairs of wires. Although there are two power conductors shown in FIG. 5, there may be more power conductors (e.g., four power conductors) depending on the cable variant (e.g., more power conductors may be used to reduce individual wire size and reduce overall cable diameter as smaller conductors pack better than larger conductors). The ground conductor 422 is used as a ground and sized to meet regulatory safety requirements. The signal conductor 424 is used to carry data signals and may include multiple wires, which can be bunched together or distributed throughout the charging cable 500. The number of cooling channels is exemplary. In other embodiments, there may be one, or more than two, cooling channels.

FIG. 5 is not to scale. The sizes of the conductors (e.g., the power conductors 420A and 420B, the ground conductor 422, and the signal conductor 424) and/or the size of the cooling channels 510A and 510B can vary, which can impact the diameter of the charging cable 500. For example, larger conductors typically lead to a larger cable diameter compared with relatively smaller conductors.

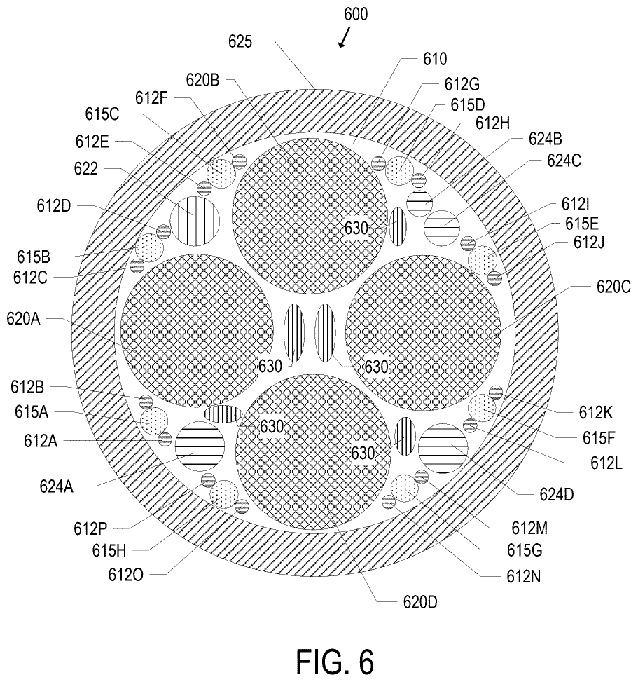

FIG. 6 illustrates a cross-section view of an EV cable that includes cable protection according to an embodiment. In the embodiment shown in FIG. 6, the protective elements of the EV charging cable 600 are integrated into the construction of the charging cable 600 like that of FIG. 4. For example, the protective elements of the charging cable are within the core of the charging cable 600. In the embodiment shown in FIG. 6, at least some of the non-protective filler is replaced with the protective elements (e.g., hard metal cordages, cut resistant plastic cordages).

The example shown in FIG. 6 is for a charging cable 600 that includes four power conductors and has eight hard metal cordages. Specifically, the core 610 of the charging cable 600 includes conductors (the power conductors 620A-620D, the ground conductor 622, and the signal conductors 624A-624D) and the protective elements (the hard metal cordages 615A-615H and the cut resistant plastic cordages 612A-612P). The power conductors 620A-620D are used to carry the rated current. For example, in a DC case, a typical DC current is between 80 A 600 A. The size of each power conductor may be between 16 mm²-70 mm² or 8 AWG-3/0 AWG, for example. A cable with four 50 mm² power conductors may be rated for 375 A, a cable with four 3 AWG power conductors may be rated for 250 A, a cable with four 1/0 AWG power conductors may be rated for 400 A. The ground conductor 622 is used as a ground and sized to meet regulatory safety requirements. As an example, the size of the ground conductor can be between 2.5 mm²-50 mm² or 14 AWG-1/0 AWG. The signal conductors 624A-624D are used to carry data signals (e.g., control pilot, proximity, etc.). The core 610 also includes a number of non-protective filler elements 630, which help keep the charging cable 600 uniform by preventing gaps between the different elements. The number and size of the non-protective filler elements can be different from what is shown in FIG. 6.

Each of the hard metal cordages 615A-615H is like one of the hard metal cordages 115A-115E. Each hard metal cordage 615 is a metal material that provides strength and resilience to most cutting tools. The hardness of the hard metal cordage will dull or damage typical cutting blades. The hardness of the hard metal cordage provides a high level of resistance to power tools requiring more time to cut through. However, the hardness of the hard metal cordage is weak to high levered force hardened tool steel typical of tools with a small cutting surface like a bolt cutter. A common cutting tool has cutting edges that are between 600-750 HV (Vickers Hardness). In an embodiment, a steel that has a hardness level above a low-carbon steel may be used as the hard metal cordage (e.g., a medium-carbon steel that ranges between 150-550 HV, a high-carbon steel that ranges between 200-850 HV, tool steel (e.g., High-Speed Steel (HSS)) that ranges between 700-850 HV, stainless steel that ranges between 200-600 (e.g., stainless steel type 316 is between 300-400 HV), chromoly steel that ranges between 300-700,and maraging steel that ranges between 500-700). The material is twisted, braided, or otherwise formed in a rope, cable, or metal band (e.g., steel rope, steel cable, steel band). The hard metal cordages 615A-615H may be between 1 mm and 5 mm in diameter.

The positioning of the hard metal cordages within the cable 600 helps to protect the cable. In an embodiment, the hard metal cordages are arranged approximately symmetrically (e.g., as shown in the figure). This symmetrical arrangement offers more protection compared to other spacing configurations, such as bunching, which can make cutting the cordages easier.

The core 610 also includes the cut resistant plastic cordages 612A-612P. The cut resistant plastic cordages are resistant to cutting blades and can be made from material such as Kevlar or High Molecular Weight Polyethylene (HMWPE). The cut resistant plastic cordage acts as a fouling mechanism. Reciprocating blades will pull the strands into the cutting area resulting and bunching and slowing of the tool. Its resilience to cutting allows it to slip between cutting blades of shear style cutters. Even a smooth sharp blade requires a sawing motion to get through the cut resistant plastic cordage. However, the weakness of the cut resistant plastic cordage is heat typical to grinding wheel style cutters.

The use of the cut resistant plastic cordage and the hard metal cordage together provides for a wide range of coverage and overlap of protection resulting in a high rate of tool fouling or damage.

As shown in FIG. 6, there are two bundles of cut resistant plastic cordage on opposing sides of each hard metal cordage. Although FIG. 6 shows two bundles of cut resistant plastic cordage on opposing sides of each hard metal cordage, in other embodiments there may be one bundle of cut resistant plastic cordage for each hard metal cordage, in other embodiments there may be more than two bundles of cut resistant plastic cordage for each hard metal cordage, and in other embodiments there may be any combination of the number of cut resistant plastic cordages for each hard metal cordage.

The internal elements of the core 610 can be twisted throughout the length of the cable 600 or can be arranged in a straight line. The internal elements of the core 610 can be wrapped in a fabric (e.g., a tape) to bundle the elements together into a tight bundle for extrusion.

A cable jacket 625 surrounds the core 610. The cable jacket 625 protects the internal components from environmental factors and mechanical stresses. The cable jacket 625 can be made from UL62 EV or EVE materials.

FIG. 6 is not to scale. Although FIG. 6 shows the ground conductor 622 being smaller in size compared to the power conductors 620A-620D, the ground conductor 622 may be the same size, or larger, than the power conductors 620A-620D. As an example, the size of the ground conductor could be 50 mm² and the size of each power conductor could be smaller than 50 mm² (e.g., 16 mm²). The diameter of the charging cable 600 may also increase with relatively larger conductors. Using FIG. 6 as an example, if the ground conductor 622 is the same size or larger than the power conductors 620A-620D, the outer diameter of the charging cable 600 would be increased to accommodate the conductors.

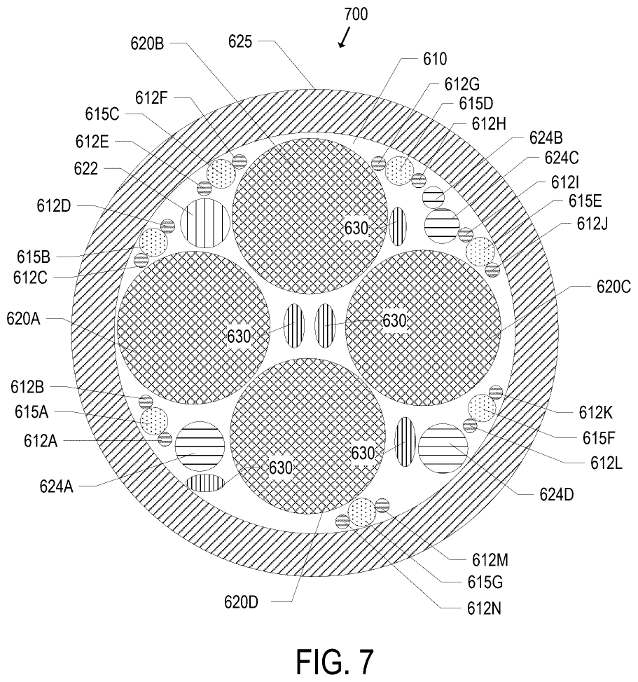

FIG. 7 illustrates a cross-section view of an EV cable that includes cable protection according to an embodiment. The charging cable 700 is like the charging cable 600 except that it has seven hard metal cordages instead of eight hard metal cordages and has more non-protective filler. Thus, the example shown in FIG. 7 is for a charging cable 700 that includes four power conductors and seven hard metal cordages. FIG. 7 is not to scale. Although FIG. 7 shows the ground conductor 622 being smaller in size compared to the power conductors 620A-620D, the ground conductor 622 may be the same size, or larger, than the power conductors 620A-620D. As an example, the size of the ground conductor could be 50 mm² and the size of each power conductor could be smaller than 50 mm² (e.g., 16 mm²). The diameter of the charging cable 700 may also increase with relatively larger conductors. Using FIG. 7 as an example, if the ground conductor 622 is the same size or larger than the power conductors 620A-620D, the outer diameter of the charging cable 700 would be increased to accommodate the conductors.

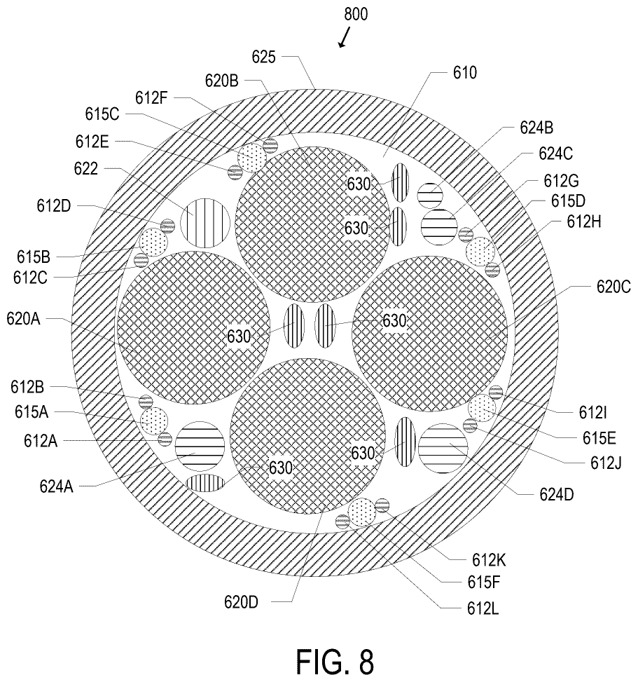

FIG. 8 illustrates a cross-section view of an EV cable that includes cable protection according to an embodiment. The charging cable 800 is like the charging cable 600 except that it has six hard metal cordages instead of eight hard metal cordages and has more non-protective filler. Thus, the example shown in FIG. 8 is for a charging cable 800 that includes four power conductors and six hard metal cordages. FIG. 8 is not to scale. Although FIG. 8 shows the ground conductor 622 being smaller in size compared to the power conductors 620A-620D, the ground conductor 622 may be the same size, or larger, than the power conductors 620A-620D. As an example, the size of the ground conductor could be 50 mm² and the size of each power conductor could be smaller than 50 mm² (e.g., 16 mm²). The diameter of the charging cable 800 may also increase with relatively larger conductors. Using FIG. 8 as an example, if the ground conductor 622 is the same size or larger than the power conductors 620A-620D, the outer diameter of the charging cable 800 would be increased to accommodate the conductors.

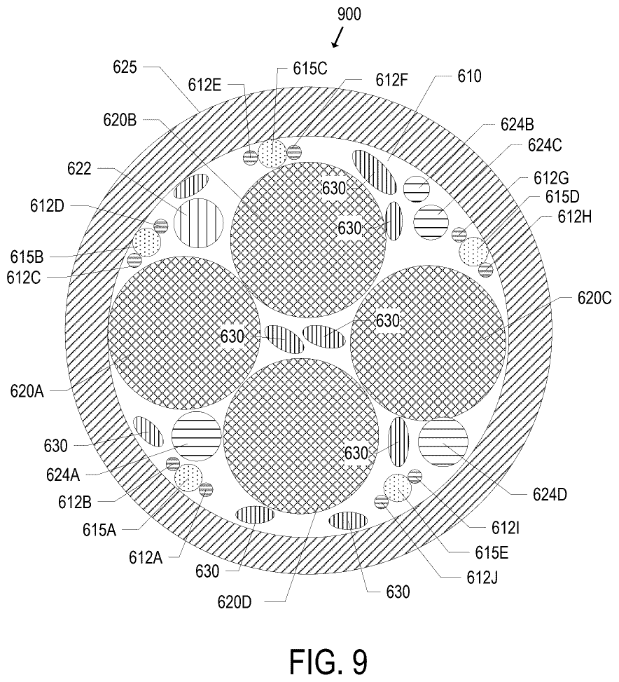

FIG. 9 illustrates a cross-section view of an EV cable that includes cable protection according to an embodiment. The charging cable 900 is like the charging cable 600 except that it has five hard metal cordages instead of eight hard metal cordages and has more non-protective filler. Thus, the example shown in FIG. 9 is for a charging cable 900 that includes four power conductors and five hard metal cordages. FIG. 9 is not to scale. Although FIG. 9 shows the ground conductor 622 being smaller in size compared to the power conductors 620A-620D, the ground conductor 622 may be the same size, or larger, than the power conductors 620A-620D. As an example, the size of the ground conductor could be 50 mm² and the size of each power conductor could be smaller than 50 mm² (e.g., 16 mm²). The diameter of the charging cable 900 may also increase with relatively larger conductors. Using FIG. 9 as an example, if the ground conductor 622 is the same size or larger than the power conductors 620A-620D, the outer diameter of the charging cable 900 would be increased to accommodate the conductors.

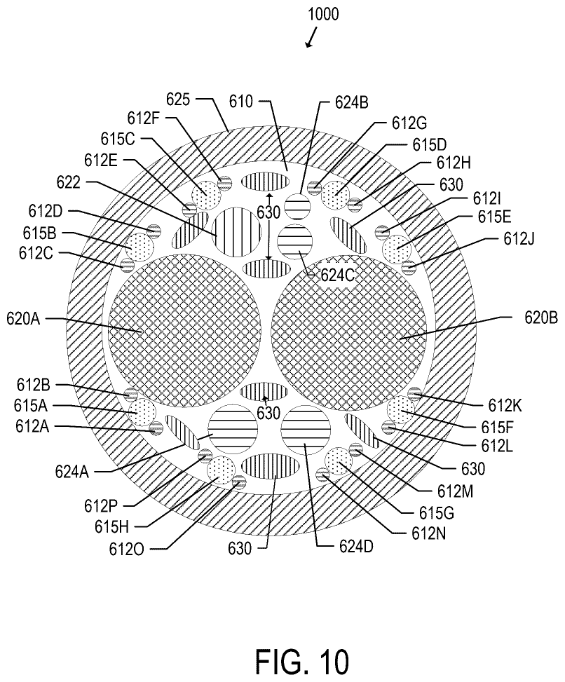

FIG. 10 illustrates a cross-section view of an EV cable that includes cable protection according to an embodiment. The charging cable 1000 is like the charging cable 600 except that it has two power conductors instead of four power conductors. Thus, the example shown in FIG. 10 is for a charging cable 1000 that includes two power conductors and eight hard metal cordages. FIG. 10 is not to scale. Although FIG. 10 shows the ground conductor 622 being smaller in size compared to the power conductors 620A-620D, the ground conductor 622 may be the same size, or larger, than the power conductors 620A-620D. As an example, the size of the ground conductor could be 50 mm² and the size of each power conductor could be smaller than 50 mm² (e.g., 16 mm²). The diameter of the charging cable 1000 may also increase with relatively larger conductors. Using FIG. 10 as an example, if the ground conductor 622 is the same size or larger than the power conductors 620A-620D, the outer diameter of the charging cable 1000 would be increased to accommodate the conductors.

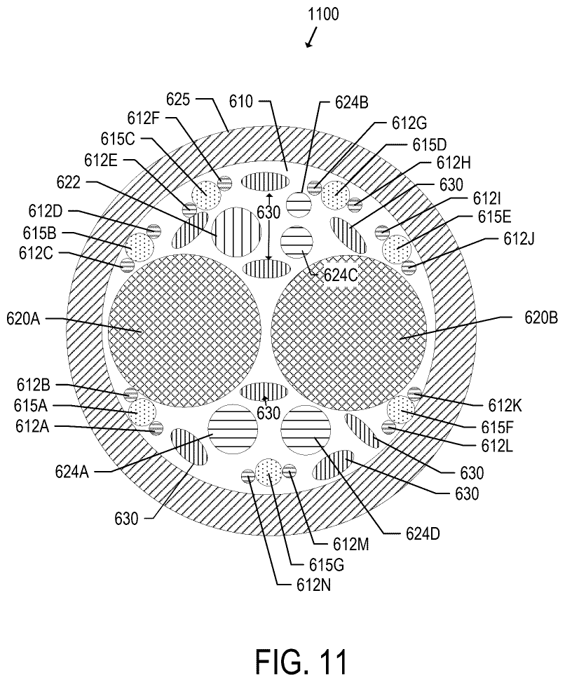

FIG. 11 illustrates a cross-section view of an EV cable that includes cable protection according to an embodiment. The charging cable 1100 is like the charging cable 700 except that it has two power conductors instead of four power conductors. Thus, the example shown in FIG. 11 is for a charging cable 1100 that includes two power conductors and seven hard metal cordages. FIG. 11 is not to scale. Although FIG. 11 shows the ground conductor 622 being smaller in size compared to the power conductors 620A-620D, the ground conductor 622 may be the same size, or larger, than the power conductors 620A-620D. As an example, the size of the ground conductor could be 50 mm² and the size of each power conductor could be smaller than 50 mm² (e.g., 16 mm²). The diameter of the charging cable 1000 may also increase with relatively larger conductors. Using FIG. 11 as an example, if the ground conductor 622 is the same size or larger than the power conductors 620A-620D, the outer diameter of the charging cable 1100 would be increased to accommodate the conductors.

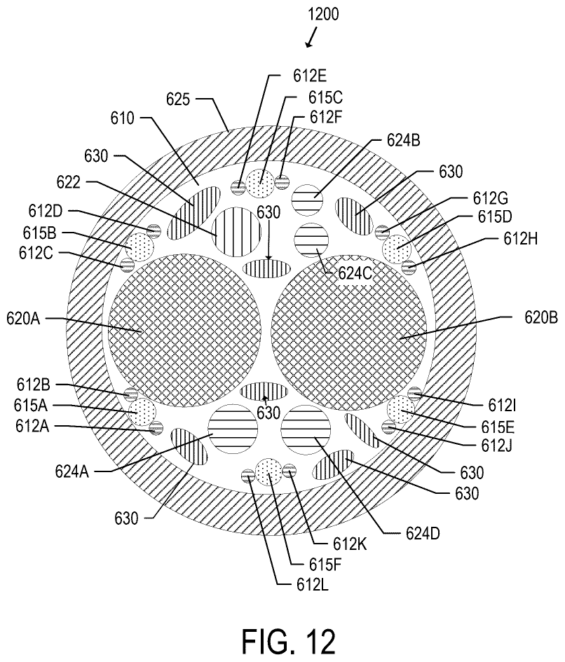

FIG. 12 illustrates a cross-section view of an EV cable that includes cable protection according to an embodiment. The charging cable 1200 is like the charging cable 800 except that it has two power conductors instead of four power conductors. Thus, the example shown in FIG. 12 is for a charging cable 1200 that includes two power conductors and six hard metal cordages. FIG. 12 is not to scale. Although FIG. 12 shows the ground conductor 622 being smaller in size compared to the power conductors 620A-620D, the ground conductor 622 may be the same size, or larger, than the power conductors 620A-620D. As an example, the size of the ground conductor could be 50 mm² and the size of each power conductor could be smaller than 50 mm² (e.g., 16 mm²). The diameter of the charging cable 1200 may also increase with relatively larger conductors. Using FIG. 12 as an example, if the ground conductor 622 is the same size or larger than the power conductors 620A-620D, the outer diameter of the charging cable 1200 would be increased to accommodate the conductors.

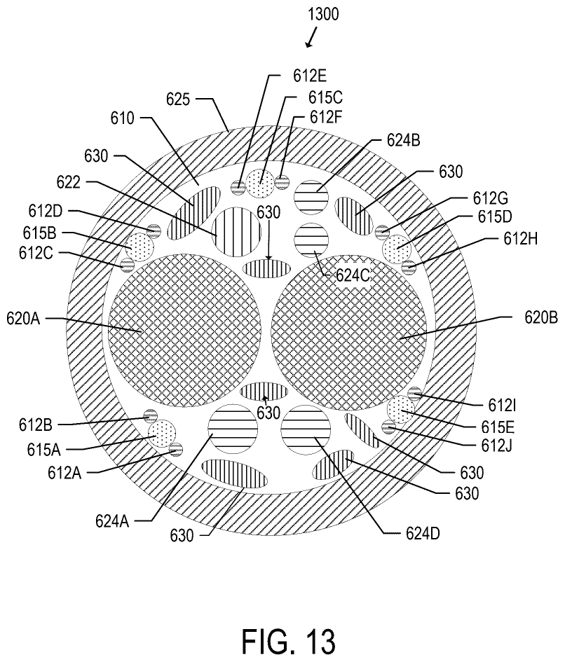

FIG. 13 illustrates a cross-section view of an EV cable that includes cable protection according to an embodiment. The charging cable 1300 is like the charging cable 900 except that it has two power conductors instead of four power conductors. Thus, the example shown in FIG. 13 is for a charging cable 1300 that includes two power conductors and five hard metal cordages. FIG. 13 is not to scale. Although FIG. 13 shows the ground conductor 622 being smaller in size compared to the power conductors 620A-620D, the ground conductor 622 may be the same size, or larger, than the power conductors 620A-620D. As an example, the size of the ground conductor could be 50 mm² and the size of each power conductor could be smaller than 50 mm² (e.g., 16 mm²). The diameter of the charging cable 1300 may also increase with relatively larger conductors. Using FIG. 13 as an example, if the ground conductor 622 is the same size or larger than the power conductors 620A-620D, the outer diameter of the charging cable 1300 would be increased to accommodate the conductors.

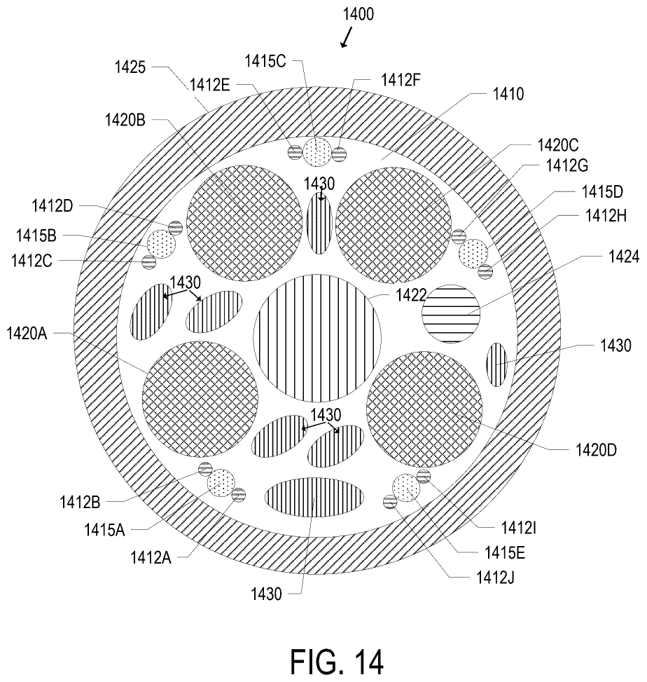

FIG. 14 illustrates a cross-section view of an EV cable that includes cable protection according to an embodiment. In the embodiment shown in FIG. 14, the protective elements of the EV charging cable 1400 are integrated into the construction of the charging cable 1400 like that of FIG. 4. For example, the protective elements of the charging cable are within the core of the charging cable 1400. In the embodiment shown in FIG. 14, at least some of the non-protective filler is replaced with the protective elements (e.g., hard metal cordages, cut resistant plastic cordages).

The example shown in FIG. 14 is for a charging cable 1400 that includes four power conductors and has five hard metal cordages. Specifically, the core 1410 of the charging cable 1400 includes conductors (the power conductors 1420A-1420D, the ground conductor 1422, and the signal conductor 1424) and the protective elements (the hard metal cordages 1415A-1415E and the cut resistant plastic cordages 1412A-1412J). The power conductors 1420A-1420D are used to carry the rated current. The ground conductor 1422 is used as a ground and sized to meet regulatory safety requirements. As an example, the size of each power conductor 1420 may be 9 AWG and the size of the ground conductor 1422 may be 8 AWG. As another example, the size of each power conductor 1420 may be 12 AWG and the size of the ground conductor 1422 may be 10 AWG. The signal conductor 1424 is used to carry data signals. The core 1410 also includes a number of non-protective filler elements 1430, which help keep the charging cable 1400 uniform by preventing gaps between the different elements. The number and size of the non-protective filler elements can be different from what is shown in FIG. 14.

Each of the hard metal cordages 1415A-1415E is like one of the hard metal cordages 115A-115E. Each hard metal cordage 1415 is a metal material that provides strength and resilience to most cutting tools. The hardness of the hard metal cordage will dull or damage typical cutting blades. The hardness of the hard metal cordage provides a high level of resistance to power tools requiring more time to cut through. However, the hardness of the hard metal cordage is weak to high levered force hardened tool steel typical of tools with a small cutting surface like a bolt cutter. A common cutting tool has cutting edges that are between 600-750 HV (Vickers Hardness). In an embodiment, a steel that has a hardness level above a low-carbon steel may be used as the hard metal cordage (e.g., a medium-carbon steel that ranges between 150-550 HV, a high-carbon steel that ranges between 200-850 HV, tool steel (e.g., High-Speed Steel (HSS)) that ranges between 700-850 HV, stainless steel that ranges between 200-600 (e.g., stainless steel type 316 is between 300-400 HV), chromoly steel that ranges between 300-700,and maraging steel that ranges between 500-700). The material is twisted, braided, or otherwise formed in a rope, cable, or metal band (e.g., steel rope, steel cable, steel band). The hard metal cordages 1415A-1415E may be between 1 mm and 5 mm in diameter.

The positioning of the hard metal cordages within the cable 1400 helps to protect the cable. In an embodiment, the hard metal cordages are arranged approximately symmetrically (e.g., as shown in the figure). This symmetrical arrangement offers more protection compared to other spacing configurations, such as bunching, which can make cutting the cordages easier.

The core 1410 also includes the cut resistant plastic cordages 1412A-1412J. The cut resistant plastic cordages are resistant to cutting blades and can be made from material such as Kevlar or High Molecular Weight Polyethylene (HMWPE). The cut resistant plastic cordage acts as a fouling mechanism. Reciprocating blades will pull the strands into the cutting area resulting and bunching and slowing of the tool. Its resilience to cutting allows it to slip between cutting blades of shear style cutters. Even a smooth sharp blade requires a sawing motion to get through the cut resistant plastic cordage. However, the weakness of the cut resistant plastic cordage is heat typical to grinding wheel style cutters.

The use of the cut resistant plastic cordage and the hard metal cordage together provides for a wide range of coverage and overlap of protection resulting in a high rate of tool fouling or damage.

As shown in FIG. 14, there are two bundles of cut resistant plastic cordage on opposing sides of each hard metal cordage. Although FIG. 14 shows two bundles of cut resistant plastic cordage on opposing sides of each hard metal cordage, in other embodiments there may be one bundle of cut resistant plastic cordage for each hard metal cordage, in other embodiments there may be more than two bundles of cut resistant plastic cordage for each hard metal cordage, and in other embodiments there may be any combination of the number of cut resistant plastic cordages for each hard metal cordage.

The internal elements of the core 1410 can be twisted throughout the length of the cable 1400 or can be arranged in a straight line. The internal elements of the core 1410 can be wrapped in a fabric (e.g., a tape) to bundle the elements together into a tight bundle for extrusion.

A cable jacket 1425 surrounds the core 1410. The cable jacket 1425 protects the internal components from environmental factors and mechanical stresses. The cable jacket 1425 can be made from UL62 EV or EVE materials.

FIG. 14 is not to scale. Although FIG. 13 shows the ground conductor 622 being smaller in size compared to the power conductors 620A-620D, the ground conductor 622 may be the same size, or larger, than the power conductors 620A-620D. As an example, the size of the ground conductor could be 50 mm² and the size of each power conductor could be smaller than 50 mm² (e.g., 16 mm²). The diameter of the charging cable 1300 may also increase with relatively larger conductors. Using FIG. 13 as an example, if the ground conductor 622 is the same size or larger than the power conductors 620A-620D, the outer diameter of the charging cable 1300 would be increased to accommodate the conductors.

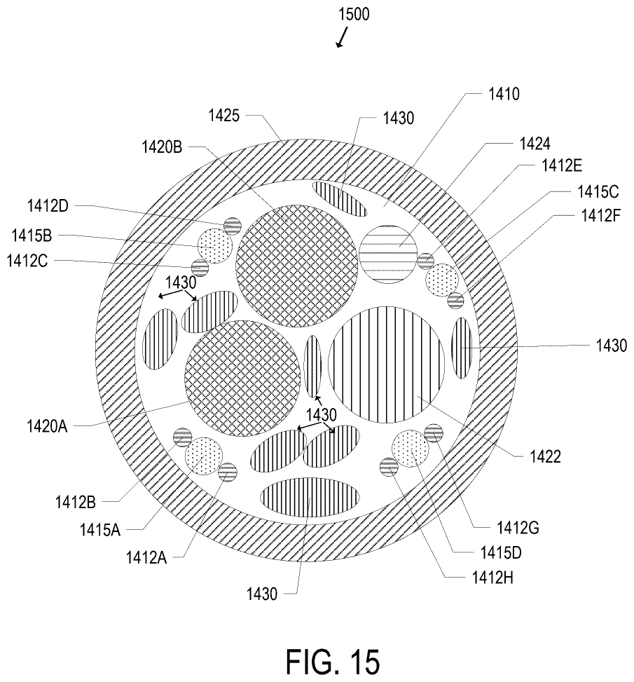

FIG. 15 illustrates a cross-section view of an EV cable that includes cable protection according to an embodiment. The charging cable 1500 is like the charging cable 1400 except that it has two power conductors 1420A and 1420B instead of four power conductors. The power conductors and/or the ground conductor may be a different size compared to the charging cable 1400. For example, the size of each power conductor in FIG. 15 (the power conductors 1420A and 1420B) may be between 6 AWG-8 AWG. The size of the ground conductor in FIG. 15 can be 8 AWG. Thus, the example shown in FIG. 15 is for a charging cable 1500 that includes two power conductors and four hard metal cordages.

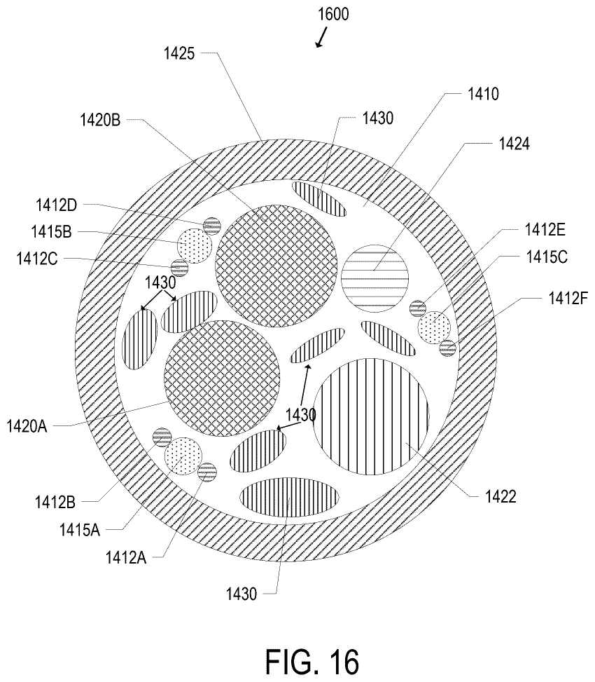

FIG. 16 illustrates a cross-section view of an EV cable that includes cable protection according to an embodiment. The charging cable 1600 is like the charging cable 1500 except that it has three hard metal cordages 1415A-1415C instead of four hard metal cordages. The power conductors and/or the ground conductor may be a different size compared to the charging cable 1500. For example, the size of each power conductor in FIG. 15 (the power conductors 1420A and 1420B) may be between 10 AWG-12 AWG. The size of the ground conductor in FIG. 16 can be between 10 AWG-12 AWG. Thus, the example shown in FIG. 16 is for a charging cable 1600 that includes two power conductors and three hard metal cordages.

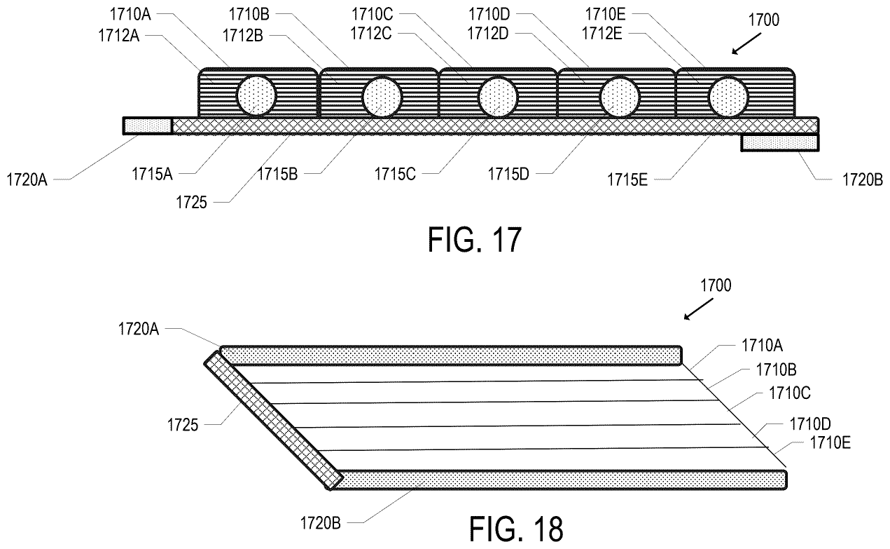

FIG. 17 illustrates a cross-section view of cable protection for an EV cable according to an embodiment. In the embodiment shown in FIG. 17, a protective wrap 1700 is placed around an existing EV charging cable. The protective wrap 1700 may cover the entire length of the cable from the point it attaches to the EVSE to the cable connector. The charging components (e.g., power conductors, communication wire(s), ground wire(s), insulation, cooling channel(s), etc.) of the existing EV charging cable are within a cable jacket.

The protective wrap 1700 includes the hard metal cordages that are placed within the foam filler components 1712A-1712E respectively. The hard metal cordages 1715A-1715E may be between 1 mm-5 mm in diameter. The material is twisted, braided, or otherwise formed in a rope, cable, or metal band (e.g., steel rope, steel cable, steel band). Although there are five hard metal cordages and foam filler components illustrated in FIG. 17, the number is exemplary. In other embodiments there may be more, or less, hard metal cordages and foam filler components. The foam filler components 1712A-1712E are placed within the stitched pockets 1710A-1710E respectively. The stitched pockets 1710A-1710E are affixed to the backing 1725. The protective wrap 1700 wraps around an EV charging cable and is secured with a hook-and-loop fastener 1720A and 1720B, which are affixed to the backing 1725. The direction of the pockets, which run parallel to the charging cable, is intended to avoid 90 degree cuts (or substantially near 90 degree cuts) of the cable. The protective wrap may be built using an offset design to spiral wrap an EV charging cable, shown in FIG. 18. The spiral wrap angle increases the area that is needed to cut through the protective wrap 1700.

Although not shown in FIGS. 17 and 18, fixing bands (e.g., metal zip ties, cosmetic band with fixing screws) may be used to secure the ends of the wrap 1700 on the EV charging cable. The fixing bands may also be placed at fixed lengths along the cable to secure the protective wrap 1700 and prevent it from being easily removed.

Although FIGS. 17 and 18 describe the protective wrap being secured with a hook-and-loop fastener, in other embodiments different kinds of fasteners may be used to secure the protective wrap such as magnetic closures, snaps, zippers, adhesive strips, or any combination.

The protective wrap embodiment can be used for retrofitting existing charging cables with enhanced protection without the need to replace the entire cable. The integrated protective cable embodiment can be used for new installations or replacement for existing cables.

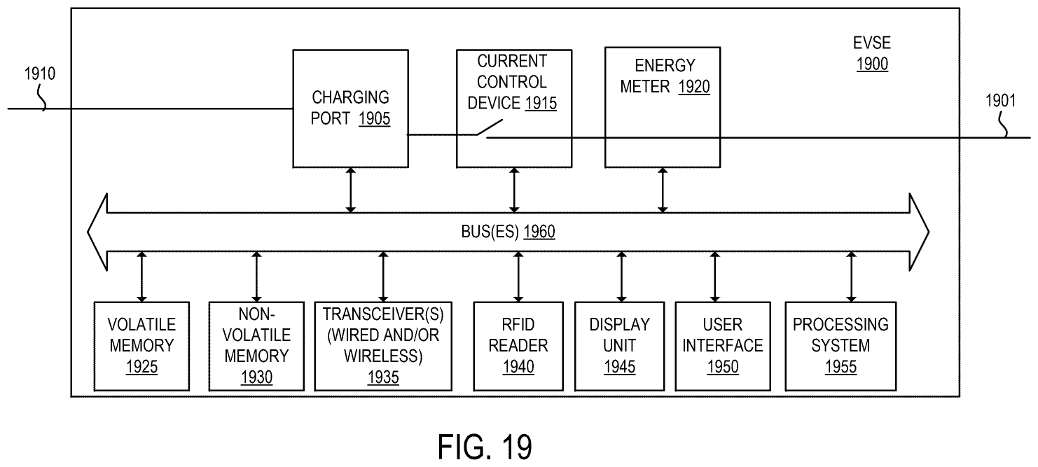

FIG. 19 shows an exemplary embodiment of an electric vehicle supply equipment (EVSE), sometimes called an EV charging station, according to an embodiment. As illustrated in FIG. 19, the EVSE 1900 includes the charging port 1905, the current control device 1915, the energy meter 1920, the volatile memory 1925, the non-volatile memory 1930 (e.g., hard drive, flash, PCM, etc.), one or more transceiver(s) 1935 (e.g., wired transceiver(s) (e.g., Ethernet, power line communication (PLC), etc.) and/or wireless transceiver(s) (e.g., 802.15.4 (e.g., ZigBee, etc.), RF, Bluetooth, Wi-Fi, Infrared, GPRS/GSM, CDMA, etc.)), the RFID reader 1940, the display unit 1945, the user interface 1950, and the processing system 1955 (e.g., one or more microprocessors and/or a system on an integrated circuit), which may be coupled with one or more buses 1960.

The charging port 1905 is a power receptacle (e.g., for receiving a charging cable plug), circuitry for an attached charging cord cable, or circuitry for wireless charging. While FIG. 19 illustrates a single charging port 1905, the EVSE 1900 may include multiple charging ports and which may be the same or different types. One end of a charging cable 1910 connects to the charging port 1905 and the other end connects to an electric vehicle. The charging cable 1910 may include any of the integrated protection embodiments described herein. Alternatively, or additionally, the charging cable 1910 may be wrapped in the protective wrap protection described herein.

The current control device 1915 controls the current flowing on the power line 1901. For example, in some embodiments the current control device 1915 energizes the charging port 1905 (e.g., by completing the circuit to the power line 1901) or de-energizes the charging port 1905 (e.g., by breaking the circuit to the power line 1901). The current control device 1915 may be a set of contactors. In some embodiments the current control device 1915 energizes the charging port 1905 responsive to receiving a command from a server that indicates charging is authorized.

The energy meter 1920 measures the amount of electricity that flows on the power line 1901 through the charging port 1905. While in one embodiment the energy meter 1920 measures current flow, in an alternative embodiment the energy meter 1920 measures power draw. The energy meter 1920 may be an induction coil or other devices suitable for measuring electricity. While the energy meter 1920 is illustrated as being included within the EVSE 1900, in other embodiments the energy meter 1920 is exterior to the EVSE 1900 but capable of measuring the amount of electricity flowing on the power line 1901 through the charging port 1905.

The RFID reader 1940 reads RFID tags from RFID enabled devices (e.g., smartcards, key fobs, contactless credit cards, etc.), embedded with RFID tag(s) of operators that want to use the EVSE 1900. For example, in some embodiments a vehicle operator can wave/swipe an RFID enabled device near the RFID reader 1940 to provide an access credential for use of the EVSE 1900.

The transceiver(s) 1935 transmit and receive messages. For example, the transceiver(s) 1935 may transmit authorization requests to the EV charging network server, receive commands from the EV charging network server indicating whether the charging session is authorized, etc. The transceiver(s) 1935 may include an RF transmitter that can trigger the opening of a charging port door of an electric vehicle inlet as described herein.

The display unit 1945 is used to display messages to vehicle operators including charging status, confirmation messages, error messages, notification messages, etc. The user interface 1950 allows operators to interact with the EVSE 1900. By way of example, the user interface 1950 allows electric vehicle operators to present an access credential, enter in account and/or payment information, etc.

The processing system 1955 may retrieve instruction(s) from the volatile memory 1925 and/or the non-volatile memory 1930 and execute the instructions to perform operations for the electric vehicle charging station.

Although several components are illustrated as being included in the EVSE 1900, in some embodiments additional, different, or less components may be used in the EVSE 1900. For example, some EVSEs may not include a display or a user interface. Other EVSEs may not include an RFID reader or an energy meter. Other EVSEs may include one or more lights that can provide visual indications.

1. An electric vehicle (EV) charging cable for charging electric vehicles, comprising:
a core of the EV charging cable that includes.
a plurality of power conductors,
a ground conductor,
one or more signal conductors,
a plurality of hard metal cordages within the EV charging cable, and
a plurality of cut resistant plastic cordages that are positioned about the plurality of hard metal cordages respectively; and
a cable jacket that directly surrounds the core of the EV charging cable.

2. The EV charging cable of claim 1, wherein the cut resistant plastic cordages are made from a Kevlar material or a High Molecular Weight Polyethylene (HMWPE) material.

3. The EV charging cable of claim 1, wherein the hard metal cordages are made from a material that has a hardness level above a low-carbon steel.

4. The EV charging cable of claim 1, wherein the hard metal cordages are made from stainless steel.

5. The EV charging cable of claim 1, wherein the diameter of each of the plurality of hard metal cordages is between 1 mm and 5 mm.

6. The EV charging cable of claim 1, wherein the plurality of hard metal cordages are positioned approximately symmetrically within the EV charging cable.

7. The EV charging cable of claim 1, wherein the core of the EV charging cable further includes:
one or more cooling channels for liquid cooling or air cooling.

8. The EV charging cable of claim 1, wherein the core of the EV charging cable further includes:
non-protective filler elements.

9. The EV charging cable of claim 1, wherein the plurality of hard metal cordages is greater than five.

10. The EV charging cable of claim 1, wherein there are at least two separate cut resistant plastic cordages for each of the plurality of hard metal cordages, and wherein the at least two cut resistant plastic cordages are positioned on opposing ends of each of the plurality of hard metal cordages.

11. An electric vehicle charging station, comprising:
a charging port to connect a charging cable;
a current control device to control current flowing on a power line through the charging cable; and
the charging cable including:
a core that includes,
a plurality of power conductors,
a ground conductor,
one or more signal conductors,
a plurality of hard metal cordages within the charging cable, and
a plurality of cut resistant plastic cordages that are positioned about the plurality of hard metal cordages respectively, and
a cable jacket that directly surrounds the core.

12. The electric vehicle charging station of claim 11, wherein the cut resistant plastic cordages are made from a Kevlar material or a High Molecular Weight Polyethylene (HMWPE) material.

13. The electric vehicle charging station of claim 11, wherein the hard metal cordages are made from a material that has a hardness level above a low-carbon steel.

14. The electric vehicle charging station of claim 11, wherein the hard metal cordages are made from stainless steel.

15. The electric vehicle charging station of claim 11, wherein the diameter of each of the plurality of hard metal cordages is between 1 mm and 5 mm.

16. The electric vehicle charging station of claim 11, wherein the plurality of hard metal cordages are positioned approximately symmetrically within the charging cable.

17. The electric vehicle charging station of claim 11, wherein the core of the charging cable further includes:
one or more cooling channels for liquid cooling or air cooling.

18. The electric vehicle charging station of claim 11, wherein the core of the charging cable further includes:
non-protective filler elements.

19. The electric vehicle charging station of claim 11, wherein the plurality of hard metal cordages is greater than five.

20. The electric vehicle charging station of claim 11, wherein there are at least two separate cut resistant plastic cordages for each of the plurality of hard metal cordages, and wherein the at least two cut resistant plastic cordages are positioned on opposing ends of each of the plurality of hard metal cordages.
